(19) United States
(12) Patent Application Publication
(10) Pub. No.: US 2005/0028874 A1
(43) Pub. Date: Feb. 10, 2005

(54) Gas distributor for reactors

(75) Inventors: Gerhard Olbert, Dossenheim (DE); Torsten Mattke, Freinsheim (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 10/902,013

(22) Filed: Jul. 30, 2004

(30) Foreign Application Priority Data
Aug. 7, 2003 (DE) 103 36 260.6

(51) Int. Cl. G05D 7/00

(52) U.S. Cl. 137/592

(57) ABSTRACT

A gas distributor for an apparatus for making the gas stream fed into the interior of the apparatus via an inlet whose hydraulic diameter is smaller than the hydraulic diameter of the apparatus uniform, wherein the gas distributor has a perforated curved surface which has a concave side and a convex side which is shaped so that its edge is matched to the interior wall of the apparatus in the region of the inlet where the concave side of the surface of the gas distributor faces the inlet and can be fitted in a fully enclosing manner to the interior wall of the apparatus, is proposed.

The present invention relates to a gas distributor for an apparatus for making the gas stream fed into the interior of the apparatus via an inlet uniform, to a method of installing the gas distributor and to its use.

It is frequently necessary to introduce a gas stream into an apparatus via an inlet whose hydraulic diameter is smaller than the hydraulic diameter of the apparatus. As a result of the change in the flow conditions as the gas stream passes from the narrower inlet into the wider interior of the apparatus, the gas stream is not distributed uniformly over the cross section of the apparatus. This leads, in particular, to problems when a continuous fixed bed is present in the apparatus, or else in respect of contact tubes filled with solid particles, for example catalysts, or gaps between heating plates.

The continuous fixed bed, the contact tubes filled with catalysts or catalyst particles or heating plates with gaps between them are frequently located in a central, cylindrical or prismatic part of the apparatus which is closed at both ends by lids or plates. The lids or plates can be, for example, flat or curved, in the form of dished ends, ends in the shape of a three-center arch or hemispherical ends.

The inlet for entry of the gas is provided in the region of an end plate or lid. Entry of the gas stream through the inlet into the interior of the apparatus can result in formation of a gas jet which impinges on the surface of the fixed bed or the tube plate into which the contact tubes are welded. This results, firstly, in nonuniform flow occurring through the fixed bed, so that the conversions are nonuniform over the cross section. Furthermore, the fixed bed can be deformed by the momentum of the impinging gas jet. In particular, a depression can be formed at the point at which the gas stream impinges and the material can be raised at other points on the surface of the fixed bed. This increases the non-uniformity of the flow of the gas stream through the fixed bed. Furthermore, when gas flows over the deformed surface of the fixed bed it is also possible for particles to be swirled up and rubbed against one another, enter the gas jet, be accelerated there and then impinge at high velocity on the surface of the fixed bed. This can lead to attrition or to destruction of the particles of the fixed bed. The consequence can be a tremendous increase in the pressure drop experienced by the gas stream over the fixed bed.

To avoid the problems described, gas distributors have been used in the region of the gas inlet. Known gas distributors are, for example, impingement plates which are arranged directly below the gas inlet and which prevent direct impingement of the gas jet on the surface of the fixed bed. The gas jet impinging on the impingement plate is deflected outward and flows along the interior wall of the reactor onto the fixed bed. This reduces the momentum of the gas jet. However, the momentum can still be high enough to cause the problems described above. In general, impingement plates cannot guarantee uniform flow onto the fixed bed.

It is possible to achieve this by means of internals such as perforated plates or the like which generate a pressure drop. These are installed over the entire cross section of the apparatus. However, such structures have the disadvantage that they produce a high pressure drop and thus increase the operating costs. Furthermore, the use of perforated plates makes it more difficult to access the fixed bed underneath them, as may be necessary, in particular, to replace exhausted catalyst in the case of a catalyst bed.

Structures made of guide plates which divide the incoming gas jet and deflect it so that it impinges on the surface of the fixed bed as a number of individual jets are also known. The advantage of such structures is the lower pressure drop. However, the complicated construction, in particular, is a disadvantage. Furthermore, the individual jets can sometimes also lead to the above-described problems.

It is an object of the present invention to provide a gas distributor for an apparatus for making the gas stream fed into the interior of the apparatus uniform, which gas distributor does not have the abovementioned disadvantages, ensures, in particular, uniform flow over the entire cross section of the apparatus, has a single construction and is correspondingly inexpensive.

We have found that this object is achieved by a gas distributor for an apparatus for making the gas stream fed into the interior of the apparatus via an inlet whose hydraulic diameter is smaller than the hydraulic diameter of the apparatus uniform, wherein the gas distributor has a perforated curved surface which has a concave side and a convex side which is shaped so that its edge is matched to the interior wall of the apparatus in the region of the inlet where the concave side of the surface of the gas distributor faces the inlet and can be fitted in a fully enclosing manner to the interior wall of the apparatus.

It has been found by means of comprehensive studies that the problem of making a gas jet entering an apparatus uniform across its cross section can be solved in a simple manner by the above-defined, approximately basket-shaped construction of the gas distributor.

The gas distributor is essentially not restricted in respect of the type of apparatus in which it can be used. The apparatus will preferably be an apparatus in which a fixed bed is located or a shell-and-tube apparatus having a plurality of contact tubes which are welded into tube plates, with an inert bed being able to be provided on the upper tube plate. Preference is also given to an apparatus having heating plates which are filled with a particulate heterogeneous catalyst and have gaps between them located therein.

In the case of these apparatuses, the consequences of nonuniform inflow of gas are particularly serious.

The problems associated with the nonuniform inflow of gas are caused by the hydraulic diameter of the inlet for the gas stream being smaller than the hydraulic diameter of the apparatus. The term “hydraulic diameter” is generally known in hydrodynamics and refers to the ratio of four times the area to the circumference of an orifice.

The gas distributor of the present invention comprises a perforated curved surface which has a concave side and a convex side and can be described as basket-shaped.

The edge of the surface has such a shape that it is matched to the interior wall of the apparatus in the region of the inlet, so that the concave side of the surface of the gas distributor faces the inlet and can be fitted in a fully enclosing manner to the interior wall of the apparatus.

The gas distributor is essentially not restricted to a particular geometry of the apparatus. This can have a cylindrical or prismatic central part whose two ends each have a closing plate or cap.

The apparatus preferably has a cylindrical central part whose two ends each have a cap. The caps can have any suitable shape, for example they can be hemispherical or have the shape of a dished end. The inlet for the gas stream and thus the gas distributor located in the region of the inlet can equally well be provided in the lower cap or in the upper cap.

The specific configuration of the curvature of the surface forming the gas distributor is in principle not restricted.

It is possible, for example, for the central region and the peripheral region of the surface to be configured differently.

The curved surface preferably has a flat central region and a peripheral region having the shape of the surface of a frustum of a cone.

It is also possible for the curved surface to have a flat central region and a peripheral region which is made up of a subregion having the shape of the surface of the frustum of a cone and a subregion having a cylindrical shape.

The curved surface of the gas distributor has to have perforations for the passage of gas.

The shape of this is in principle not restricted. They can be configured, for example, as holes or slits.

Owing to the different flow conditions, it can be advantageous to select a smaller opening ratio for the perforations in the central region of the gas distributor than for those in the peripheral region of the gas distributor.

It is advantageous to select an opening ratio in the central region of from 2% to 20% and a ratio in the peripheral region of from 4% to 40%. An opening ratio in the central region of from 3% to 10% and a ratio in the peripheral region of from 5% to 20% are more preferred. Particular preference is given to an opening ratio in the central region of from 4% to 7% and a ratio in the peripheral region of from 7% to 15%.

The central region of the curved surface of the gas distributor is advantageously circular with a diameter which is from 1 to 4 times the diameter of the inlet for the gas stream, preferably from 1.5 to 3 times the diameter of the inlet for the gas stream.

The central region of the curved surface of the gas distributor is preferably at a distance from the edge of the gas distributor of from 1 to 8 times, in particular from 2 to 4 times, the diameter of the inlet for the gas stream.

The curved surface of the gas distributor is preferably formed by a perforated metal sheet, with the ratio of the size of the perforations to the thickness of the metal sheet preferably being in the range from 0.2 to 10, in particular in the range from 3 to 5.

The present invention further provides a method of installing a gas distributor as described above in an apparatus, which comprises welding brackets onto the interior wall of the apparatus and fixing the gas distributor to these by means of screws or bolts.

The gas distributor is particularly suitable for use in an apparatus containing a continuous fixed bed located on a retaining grate.

A further preferred use is for an apparatus which is configured as a shell-and-tube apparatus having contact tubes which are welded into tube plates and having caps at the ends of the cylindrical part of the apparatus in which the contact tubes and the tube plates are installed, where the gas stream is fed in through an inlet in one cap, is passed through the contact tubes and is taken off from the apparatus via the other cap.

A further preferred use is for a shell-and-tube apparatus as described above which has an inert bed on the upper tube plate and in which the gas stream is introduced via the inlet in the upper cap of the apparatus and through the gas distributor.

Use in a heating plate reactor as described, for example, in DE 103 33 866.7 is also particularly advantageous, since the distribution and collection facilities for the heat transfer medium are additionally located in the inlet region for the gas stream in such reactors.

The invention is illustrated below with the aid of a drawing.

### IN THE DRAWING

FIG. 1 shows a longitudinal section through an apparatus provided with a preferred embodiment of a gas distributor according to the present invention, with a detail shown in FIG. 1a,

FIG. 2 shows a longitudinal section through an apparatus provided with an embodiment of a gas distributor according to the present invention in the lower cap,

FIG. 3 shows a longitudinal section through a shell-and-tube apparatus provided with a further embodiment of a gas distributor in the upper cap, with a detail shown in FIG. 3a,

FIG. 4 shows a detail of a further embodiment of a gas distributor and

FIG. 5 shows a longitudinal section through an apparatus having heating plates and provided with an embodiment of the gas distributor of the present invention.

In the figures, identical reference numerals in each case denote identical or corresponding features.

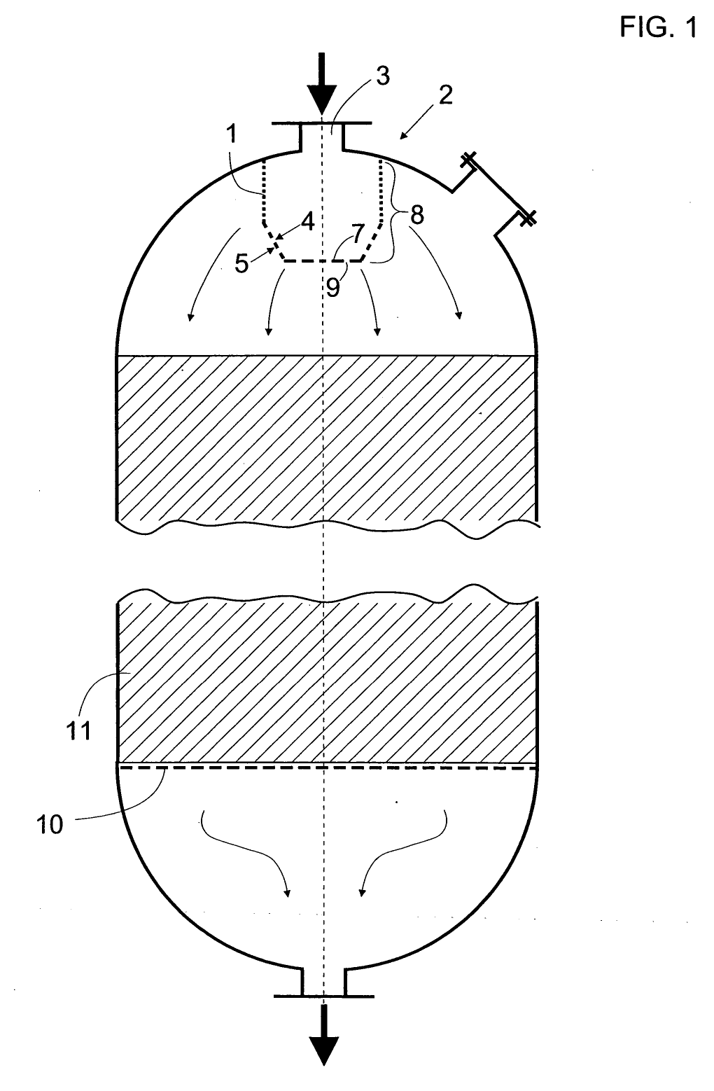

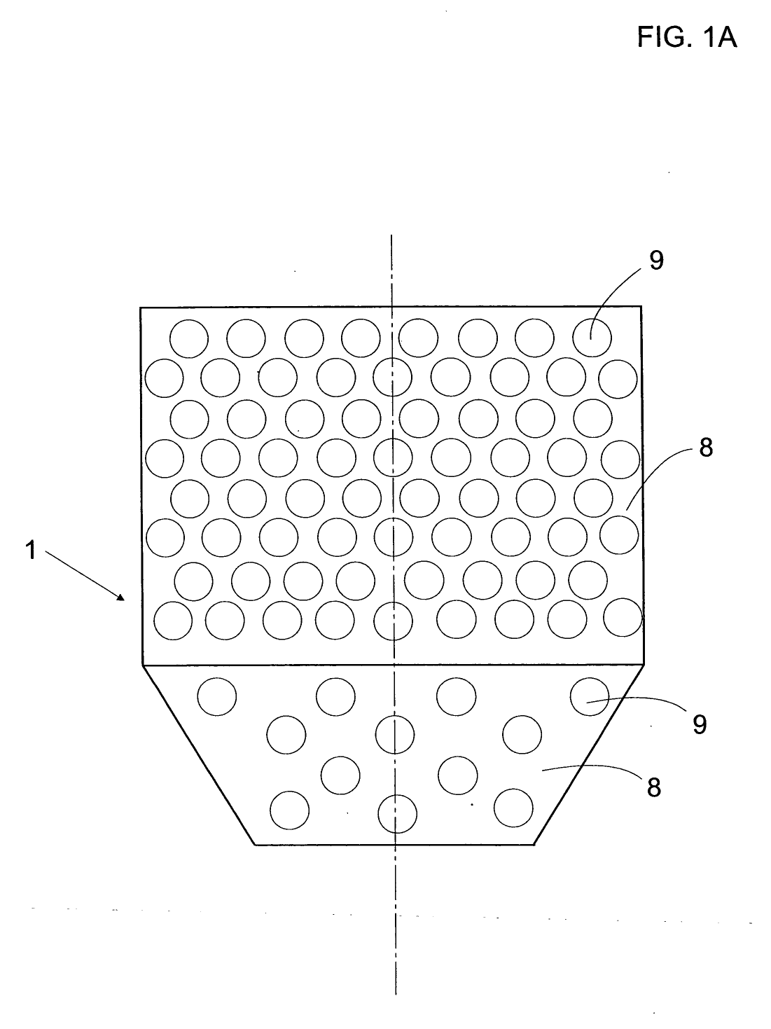

The longitudinal section in FIG. 1 depicts an apparatus 2 having a central cylindrical part whose two ends each have a hemispherical cap 6. A gas stream is introduced into the apparatus 2, in its upper cap 6, via an inlet 3, which is located centrally in the upper cap 6 in the embodiment shown by way of example in FIG. 1, and is distributed uniformly by means of a gas distributor 1. The gas distributor 1 has a concave side which faces the inlet 3 and a convex side which faces the interior of the apparatus 2. The gas distributor 1 has a central region 7 which, in the embodiment depicted, is flat and has a circular cross section and also has a peripheral region 8 which is formed by a subregion having the shape of the surface of the frustum of a cone and a further subregion having the shape of the surface of a cylinder. The gas distributor 1 has perforations 9 which, as can be seen from the figure, have a smaller opening ratio in the central region 7 and in the subregion having the shape of the surface of the frustum of a cone of the peripheral region 8 than in the cylindrical subregion of the peripheral region 8. In the central cylindrical part of the apparatus 2, a fixed bed 11 is present on a retaining grate 10.

The detail of the gas distributor 1 shown in FIG. 1a indicates the different opening ratios of the perforations 9 in the lower, cone-frustum-shaped region of the peripheral region 8 and in the upper, cylindrical subregion of the peripheral region 8.

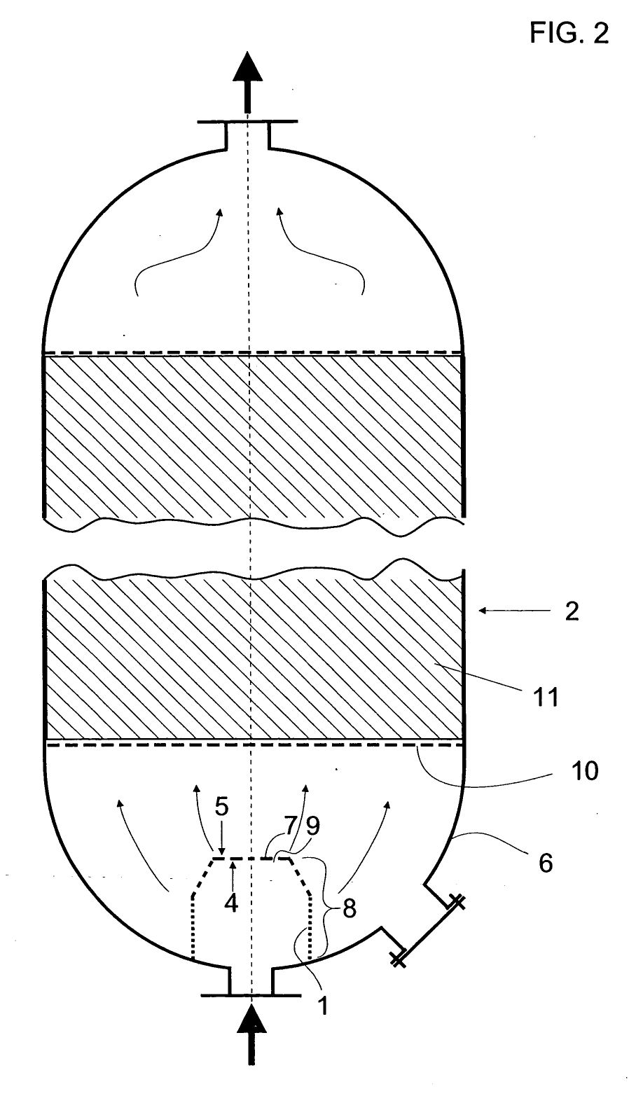

The longitudinal section depicted in FIG. 2 differs from that in FIG. 1 in the provision of the inlet 3 for the gas stream in the lower cap 6 of the apparatus 2. The gas distributor 1 itself is no different from the embodiment shown in FIG. 1. To avoid solids being carried out by the gas stream, the embodiment shown in FIG. 2 is additionally provided with a retaining grate above the fixed bed.

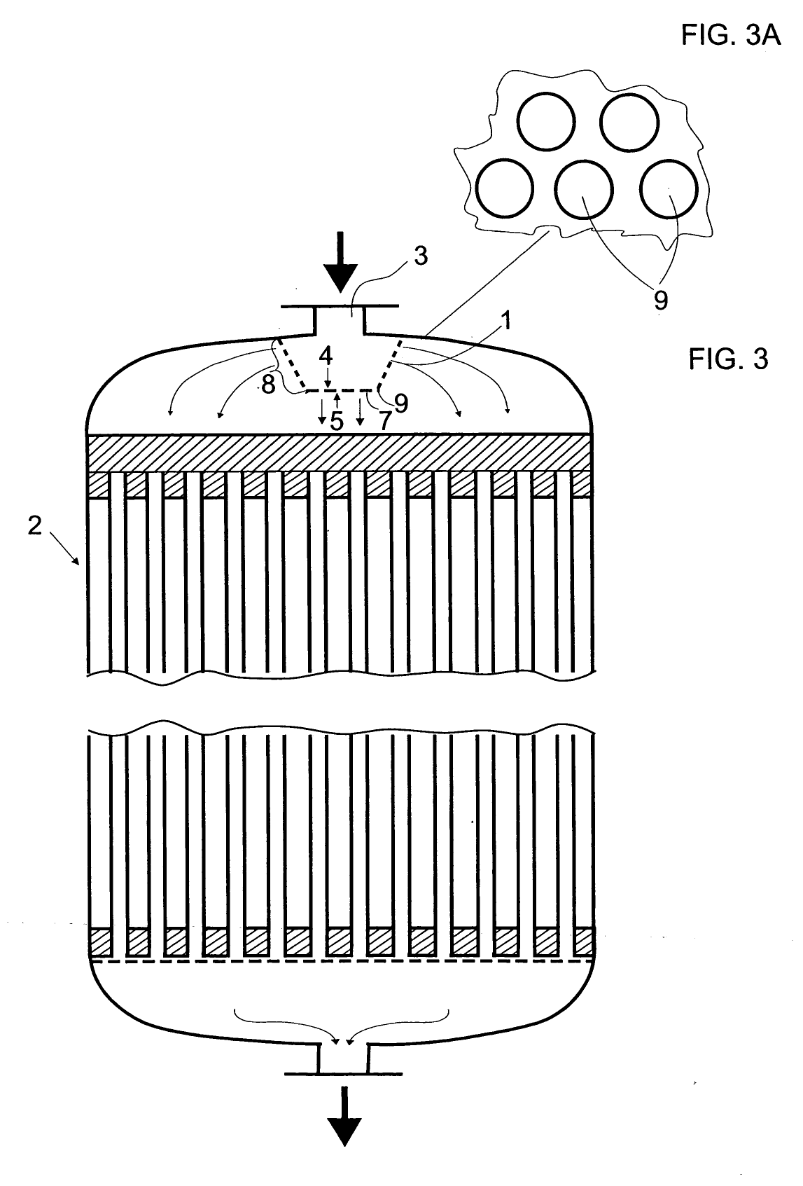

FIG. 3 shows a longitudinal section through a further apparatus 2 configured as a shell-and-tube reactor having a central cylindrical part in which the contact tubes 12 are fixed in tube plates 13. A retaining grate is provided below the lower tube plate and an inert bed is present on the upper tube plate. The gas distributor 1 differs from the embodiment shown in FIG. 1 in that it has a uniform geometry, i.e. the surface of the frustum of a cone, in its peripheral region 8. In this embodiment too, the opening ratio of the perforations in the central region 7 is smaller than in the peripheral region 8.

The detail depicted in FIG. 3a shows a preferred arrangement of the perforations 9 relative to one another.

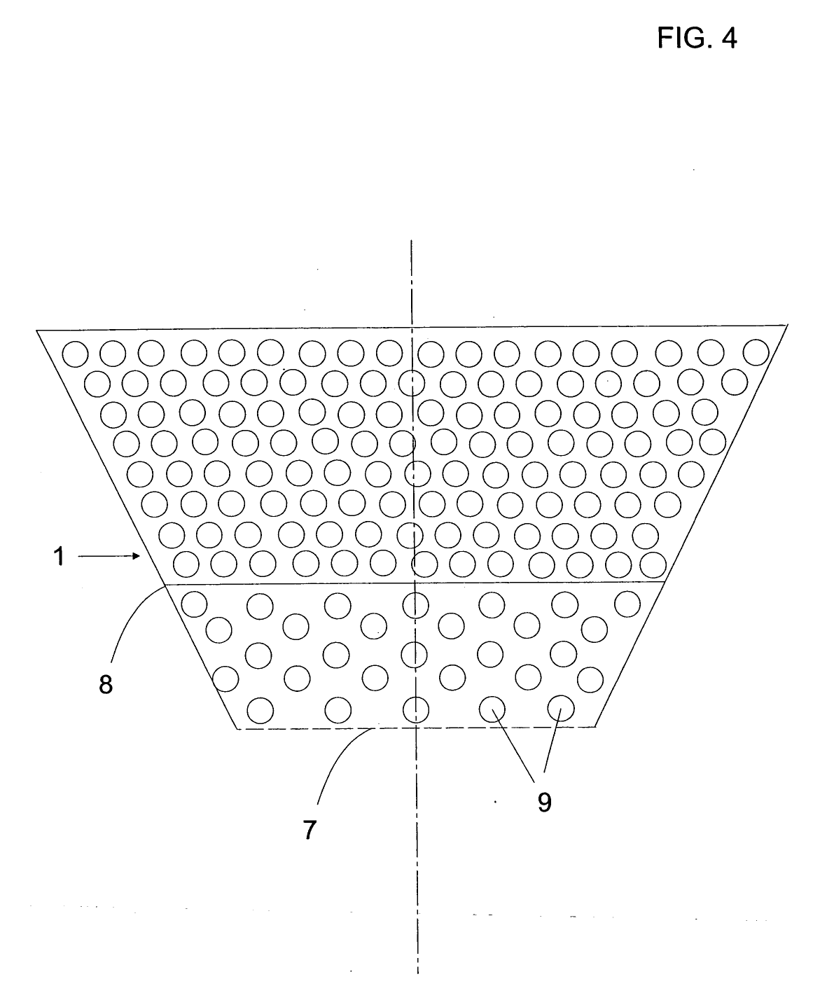

The detail depicted in FIG. 4 shows a preferred embodiment of the perforations 9 in the peripheral region 8 of a gas distributor 1, in which the opening ratio of the perforations 9 in the peripheral region 8 increases with increasing distance from the central region 7.

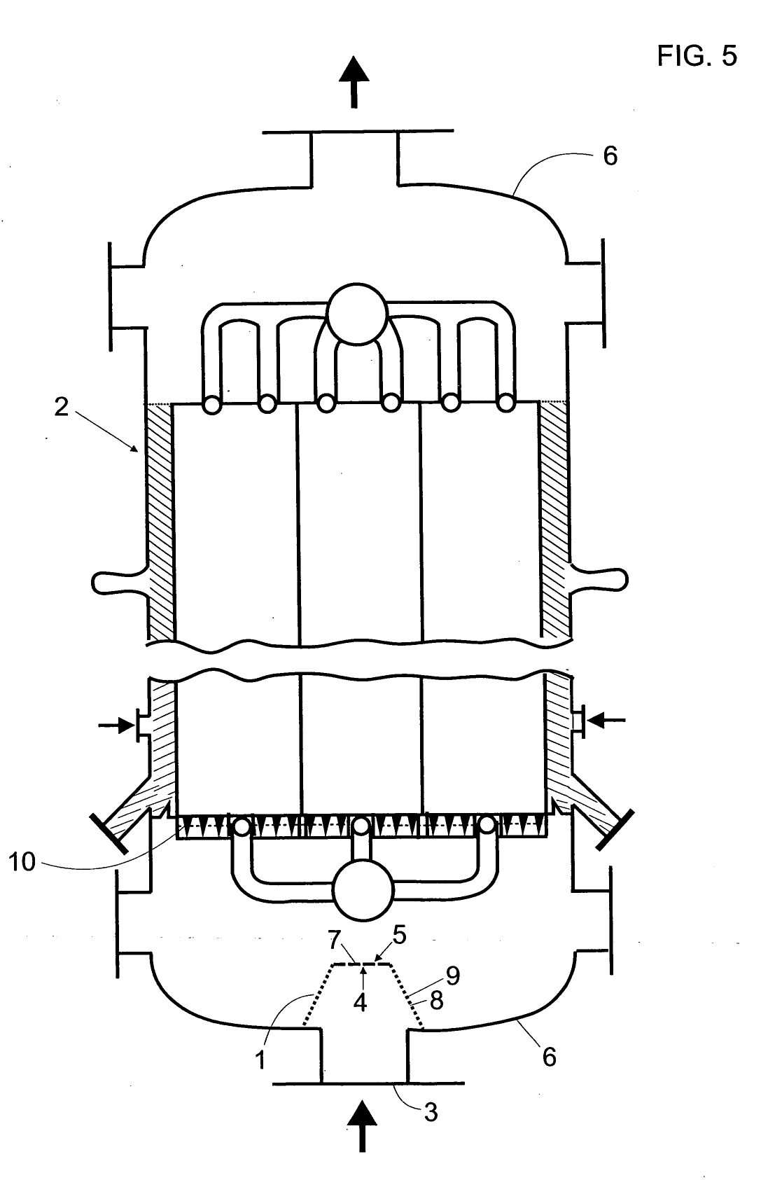

The longitudinal section depicted in FIG. 5 shows a further apparatus 2 which is equipped with heating plates, corresponding to the depiction in FIG. 1 in DE 10 2004 017 151.3, which is not a prior publication. The gas stream is introduced into the apparatus 2 via an inlet 3 located centrally in the lower cap 6 and is made uniform by means of the gas distributor 1. In the embodiment depicted, the gas distributor 1 has a geometrically uniform peripheral region 8 having the shape of a surface of frustum of a cone.

1. A gas distributor for an apparatus for making the gas stream fed into the interior of the apparatus via an inlet whose hydraulic diameter is smaller than the hydraulic diameter of the apparatus uniform, wherein the gas distributor has a perforated curved surface which has a concave side and a convex side which is shaped so that its edge is matched to the interior wall of the apparatus in the region of the inlet where the concave side of the surface of the gas distributor faces the inlet and can be fitted in a fully enclosing manner to the interior wall of the apparatus.

2. A gas distributor as claimed in claim 1, wherein the apparatus comprises a cylindrical wall whose two ends each have a cap, and the inlet for the gas stream is located in the region of one of the caps.

3. A gas distributor as claimed in claim 1, wherein the cap has a hemispherical shape or has the shape of a dished end.

4. A gas distributor as claimed in claim 1, wherein the curved surface of the gas distributor has a flat central region and a peripheral region which has the shape of the surface of a frustum of a cone.

5. A gas distributor as claimed in claim 1, wherein the curved surface of the gas distributor has a flat central region and a peripheral region which is formed by a subregion having the shape of the surface of a cylinder and a subregion having the shape of the surface of a frustum of a cone.

6. A gas distributor as claimed in claim 1, wherein the perforations are holes or slits.

7. A gas distributor as claimed in claim 1, wherein the opening ratio of the perforations in the central region of the surface of the gas distributor is less than the opening ratio of the perforations in the peripheral region of the surface of the gas distributor.

8. A gas distributor as claimed in claim 7, wherein the opening ratio of the perforations in the central region of the surface of the gas distributor is in the range from 2% to 20% and the opening ratio of the perforations in the peripheral region of the surface of the gas distributor is in the range from 4% to 40%.

9. A gas distributor as claimed in claim 7, wherein the opening ratio of the perforations in the central region of the surface of the gas distributor is in the range from 3% to 10% and the opening ratio of the perforations in the peripheral region of the surface of the gas distributor is in the range from 5% to 20%.

10. A gas distributor as claimed in claim 7, wherein the opening ratio of the perforations in the central region of the surface of the gas distributor is in the range from 4% to 7% and the opening ratio of the perforations in the peripheral region of the surface of the gas distributor is in the range from 7% to 15%.

11. A gas distributor as claimed in claim 4, wherein the central region of the surface of the gas distributor is circular with a diameter which is from 1 to 4 times the diameter of the inlet for the gas stream, preferably from 1.5 to 3 times the diameter of the inlet for the gas stream.

12. A gas distributor as claimed in claim 4, wherein the central region is at a distance from the edge of the surface forming the gas distributor which is from 1 to 8 times, preferably from 2 to 4 times, the diameter of the inlet for the gas stream.

13. A gas distributor as claimed in claim 1, wherein the gas distributor is formed by a perforated metal sheet in which the ratio of the hydraulic diameter of the perforations to the thickness of the metal sheet is from 0.2 to 10, preferably from 0.3 to 5.

14. A method of installing a gas distributor as claimed in claim 1 in an apparatus, which comprises welding brackets onto the interior wall of the apparatus in the region of the inlet for the gas stream and screwing the gas distributor onto these.

15. The use of a gas distributor as claimed in claim 1 for feeding a gas stream into an apparatus containing a continuous fixed bed located on a retaining grate.

16. A method of using a gas distributor as claimed in claim 1 for feeding a gas stream into an apparatus which is configured as a shell-and-tube apparatus having contact tubes which are welded into tube plates and having caps at the ends of the cylindrical part of the apparatus in which the contact tubes and the tube plates are installed, where the gas stream is fed in through an inlet in one cap, is passed through the contact tubes and is taken off from the apparatus via the other cap.

17. A method of using as claimed in claim 16, wherein the apparatus has an inert bed on the upper tube plate and the gas stream is fed in via the inlet in the upper cap of the apparatus and through the gas distributor.

18. A gas distributor as claimed in claim 11, wherein the diameter of the central region of the surface of the gas distributor is from 1.5 to 3 times the diameter of the inlet for the gas stream.

19. A gas distributor as claimed in claim 12, wherein the central region is at a distance from the edge of the surface forming the gas distributor which is from 2 to 4 times, the diameter of the inlet for the gas stream.

20. A gas distributor as claimed in claim 1, wherein the gas distributor is formed by a perforated metal sheet in which the ratio of the hydraulic diameter of the perforations to the thickness of the metal sheet is from 0.3 to 5.
